(19) United States
(12) Patent Application Publication
(10) Pub. No.: US 2006/0022434 A1
(43) Pub. Date: Feb. 2, 2006

(54) Jogging stroller having capacity to be pedalled by a rider

(76) Inventor: Janet Capell, Knoxville, TN (US)

Correspondence Address: MICHAEL E. McKEE;Attorney at Law, 804 Swaps Lane, Knoxville, TN, 37923, US

(21) Appl. No.: 11/189,495

(22) Filed: Jul. 26, 2005

Related U.S. Application Data
(60) Provisional application No. 60/598,139, filed on Jul. 31, 2004.

(51) Int. Cl. B62M 9/04

(52) U.S. Cl. 280/642; 280/210

(57) ABSTRACT

A jogging stroller for carrying a rider as an individual jogs behind and pushes the stroller includes a pedal assembly connected in driving relationship with at least one wheel of the stroller which permits the rider to pedal the stroller along a road surface as the stroller is pushed along the road surface by the individual.

The benefit of Provisional Application Ser. No. 60/598,139, filed Jul. 31, 2004 and entitled JOGGING STROLLER HAVING CAPACITY TO BE PEDALLED BY A RIDER, is hereby claimed. The disclosure of this referenced provisional application is incorporated herein by reference.

### BACKGROUND OF THE INVENTION

This invention relates generally to strollers and relates, more particularly, to jogging strollers which are capable of being pushed from behind by an individual as the individual jogs behind the stroller.

The class of strollers with which this invention is concerned includes those which are capable of being pushed along a road surface, or street, by an individual as the individual jogs behind the stroller. To this end, this class of strollers include a frame to which wheels are secured at the front and back thereof, and further includes a handle assembly attached to the rear of the frame which is capable of being grasped by the individual for pushing the stroller along a street. The wheels of such strollers are relatively large in diameter and are air-inflatable to enhance the comfort of the rider as the stroller is pushed along a street at a relatively rapid (e.g. jogging) pace. Furthermore, the wheels of such strollers are commonly attached to the stroller frame in a manner which prevents the direction of the wheels from being altered from a fixed, straight ahead direction. Therefore and in order to turn such a stroller, the jogger usually tilts the stroller rearwardly to lift the front wheel (or wheels) of the stroller off of the street and pivots the stroller leftwardly or rightwardly upon its rear wheels to adjust the direction of the stroller as desired.

If a conventional jogging stroller is intended to be used for a lengthy period (e.g. multiple years) with the same child riding in the stroller, the child will undoubtably grow in size over that period. Accordingly and as the child grows larger, jogging with the stroller will become more difficult. It would be desirable to provide a stroller with means by which the growing child can aid in moving the stroller along a street.

Accordingly, it is an object of the present invention to provide a new and improved jogging stroller which includes means by which a rider of the stroller can help move the stroller.

Another object of the present invention is to provide such a jogging stroller which employs means enabling the rider to provide motive force to the wheels of the stroller.

Still another object of the present invention is to provide such a stroller which is provided with pedals which can be rotated by the rider and thus aid in the movement of the stroller along a street.

Yet another object of the present invention is to provide such a stroller which is uncomplicated in structure, yet effective in operation.

### SUMMARY OF THE INVENTION

This invention resides in a jogging stroller for carrying a rider as an individual jogs behind and pushes the stroller.

The jogging stroller includes a frame, a plurality of wheels which are rotatably attached to the frame, and a seat for supporting a rider. In addition, the stroller includes a handle assembly associated with the frame enabling an individual who jogs behind the stroller to push the stroller along a road surface as the handle assembly is grasped by the individual. Still further, the stroller includes means associated with the frame and connected in driving relationship with at least one of the wheels for enabling the rider to pedal the stroller along the road surface as the stroller is pushed along the road surface by the individual.

### BRIEF DESCRIPTION OF THE DRAWINGS

FIG. 1 is a perspective view of a jogging stroller within which features of the present invention are embodied.

FIG. 2 is a fragmentary side elevational view of the FIG. 1 jogging stroller, shown generally from the left in FIG. 1.

FIG. 3 is a view similar to that of FIG. 2 of an alternative embodiment of a jogging stroller.

### DETAILED DESCRIPTION OF AN ILLUSTRATIVE EMBODIMENT

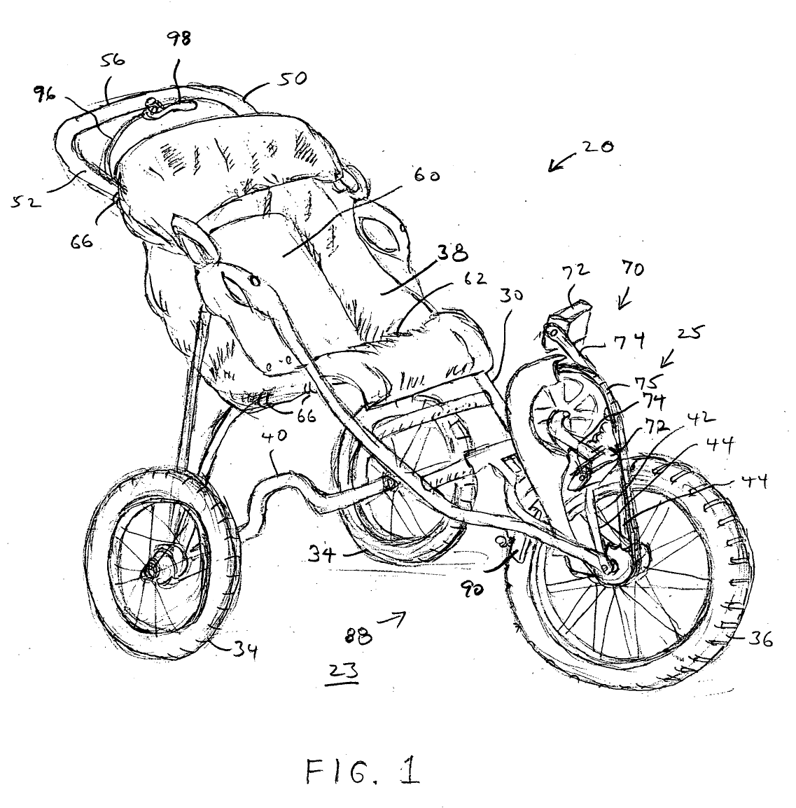

Turning now to the drawings in greater detail and considering first FIG. 1, there is illustrated an embodiment, generally indicated 20, of a jogging stroller within which features of the present invention are embodied. As the stroller 20 is used, it is pushed from behind by an individual along an underlying road surface 23 as that individual runs, or jogs, behind the stroller 20. The stroller 20 has a seat 38 for supporting a child-aged rider therein, and as will be apparent herein, the stroller 20 includes means, generally indicated 25, enabling the rider to help supply motive force for powering the stroller 20 along the road surface 23.

With reference still to FIG. 1, the stroller 20 includes a frame 30 to which a plurality of wheels 34, 36 are rotatably attached and upon which the seat 38 is supported. In the depicted stroller 20, the frame 30 is somewhat triangular in form (e.g. tricycle-like) having a back which is relatively broad and a front which is relatively narrow. Extending traversely through the back of the frame 30 is an axle 40 having two opposite ends which are disposed on opposite sides of the frame 30, and joined to the front of the frame 30 is a bifurcated member 42 having two prongs 44 which extend both downwardly and forwardly relative to the remainder of the frame 30. The frame 30 is constructed of hollow metal tubing, but any of a number of suitable materials can be utilized.

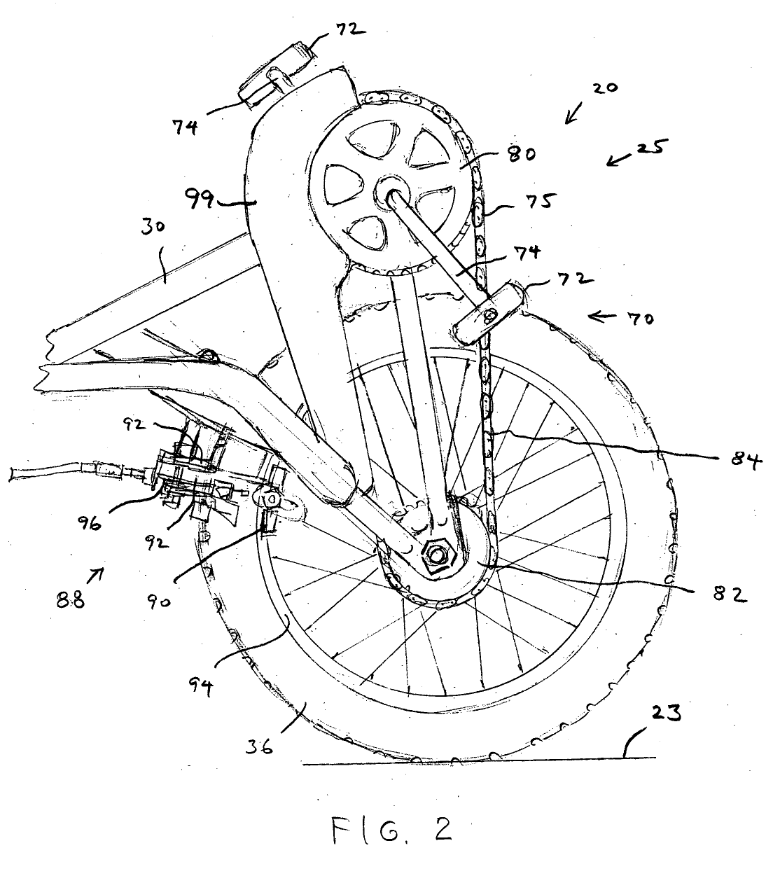

The stroller 20 depicted in FIGS. 1 and 2 has been constructed out of components taken from a conventional jogging stroller and components taken from a conventional bicycle. In particular, much of the rear section of the stroller 20 incorporates many components of the rear portion of a conventional jogging stroller, including the seat 38, the rear portion of the frame 30, the rear wheels 36, and interlocking components (disposed medially of the frame 30) which permit the frame 30 to be folded to a more compact condition for storage or transport. Meanwhile, much of the forward section of the stroller 20 incorporates many components of the rear portion of a conventional bicycle, including pedal assembly, the rear (driven) wheel 36 and the drive mechanisms interposed between the pedal assembly and the rear wheel 36. Accordingly, many of the components of the stroller 20 described herein will be familiar to those skilled in the art of jogging strollers and bicycles.

The depicted stroller 20 includes two wheels 34 situated adjacent the back of the frame 30 and a single wheel 36 situated adjacent the front of the frame 30. In this connection, each of the two rear wheels 34 is mounted upon a corresponding end of the axle 40 so that the rear wheels 34 are journaled upon the frame 30, and the front wheel 36 is positioned between the prongs 44 of the bifurcated member 42 and rotatably mounted therebetween to thereby journal the front wheel 36 upon the frame 30. Each of the back and front wheel 34 and 36 is pivotally joined to the frame 30 for rotation with respect thereto about a corresponding axis of rotation, and the direction of each wheel 34, 36 is fixed in relation to the frame 30 so that all of the wheels 34, 36 are directed in the same (i.e. straight-ahead) direction. If desired, each wheel 34 or 36 can be equipped with a fender which provides a safety partition between the rider and the corresponding wheel.

Each wheel 34 or 36 is air-inflatable in nature (complete with a bicycle-type valve which permits inflation and deflation, as necessary) and is relatively large in diameter (e.g. at least about twelve inches in diameter). It has been found that inflatable wheels of relatively large diameter enhance the comfort of the rider as the stroller 20 is pushed along a road surface at a relatively rapid (e.g. jogging pace).

The stroller 20 further includes a handle assembly 50 which is attached to the frame 30 for enabling an individual to push the stroller 20 from behind as the individual jogs behind the stroller 20. To this end, the handle assembly 50 includes a substantially U-shaped member 52 having two legs 54 and a handlebar 56 joined between the legs 54 at one end thereof. The U-shaped member 52 is appropriately attached (e.g. integrally attached) to the remainder of the frame 30 so that the handlebar 56 extends both upwardly and rearwardly from the back of the frame 30 to a position at which the handlebar can be easily grasped by an individual for pushing the stroller 20 along the road surface 23.

The U-shaped member 52 of the depicted stroller 20 is constructed of hollow metal tubing, but other materials can be employed. To enhance the comfort of the grip of the individual about the handlebar 56, the handlebar 56 can be covered with a soft, rubberized material.

The seat 38 of the depicted stroller 20 is sewn together out of canvas fabric to provide a back 60 and a seat portion 62. The seat 38 is attached to the frame 30 with cords 66 which are sewn at one end to the fabric of the seat 38 and are tied at its other end to the tubular components of the frame 30 so that the seat 38 is supported in somewhat of a suspended condition from the frame 30. In the alternative, the seat 38 can be constructed of other materials, such as being molded out of a relatively hard plastic material, and as such, can be attached to the tubular components of the frame 30 with bolts.

The means 25, introduced earlier, for enabling the rider to help supply motive force for powering the stroller 20 along the road surface 23 includes a pedal assembly, generally indicated 70 in FIGS. 1 and 2, which is connected in driving relationship with at least one of the stroller wheels for permitting the rider to pedal the stroller 20 along the road surface 23 as the stroller 20 is pushed along the road surface 23 by an individual. In the depicted stroller 20, the pedal assembly 70 includes a pair of pedals 72 which are connected to the front wheel 36 by way of a pair of cranks 74 and a sprocket and drive chain arrangement 75 (including a pair of sprockets 80 and 82 and a drive chain 84 which is looped about the sprockets 80 and 82) so that rotation of the pedals 72 about the rotation axis of the front wheel 36 effects a corresponding rotation of the wheel 36 about its rotation axis. Each pedal 72 is rotatably connected to an end of a corresponding crank 74 and is disposed within leg's reach of the rider so that as the rider remains seated upon the seat portion 62 of the seat 38, he is free to pedal the pedals 72 and thereby drivingly rotate the front wheel 36. It follows that by drivingly rotating the front wheel 36 of the stroller 20, the stroller 20 can be aided along the road surface 23 by the rider.

To enable the individual who pushes the stroller 20 along a road surface 23 to brake, and thereby slow down and/or stop, the stroller 20, there is provided a cable-actuated brake assembly 88 for interacting with the front wheel 36 and which is controllable by the individual who pushes and jogs behind the stroller 20. In this connection and as best shown in FIG. 2, the brake assembly 88 is conventional in construction and includes a pair of brake pads 90 (only one shown in FIG. 2) which are supported on opposite sides of the rim, indicated 94, of the front wheel 36 by a pair of pivotally-joined levers 92. The levers 92 are, in turn, supported by the frame 30 adjacent the front wheel 36 for movement of the pads 90 toward and away from (i.e. into and out of engagement with) the rim 94 of the wheel 36 as the levers 92 are pivotally moved relative to one another in a pincer-like movement.

Furthermore, a brake cable 96 is joined between one of the levers 92 and a brake handle 98 (FIG. 1) mounted upon the stroller handle assembly 50 so that by pulling rearwardly upon (or squeezing) the brake handle 98, the rim 94 of the front wheel 36 is pinched or tightly sandwiched between the brake pads 90 by way of the levers 92. Upon release of the brake handle 98, the pads 90 are urged apart, and thereby out of engagement with the rim 94, by way of an internal spring (not shown) which continuously biases the pads 90 apart.

It will be understood that numerous modifications and substitutions can be had to the aforedescribed embodiment without departing from the spirit of the invention. For example, although the aforedescribed stroller 20 has been shown and described as having a pedal assembly 70 which is joined to the frame 30 at a preselected distance from the seat 38, an embodiment which incorporate the features of the present invention can include means for adjusting the distance between the pedal assembly and the stroller seat. The capacity provided by such a stroller to alter the distance between its seat and its pedal assembly enables a user to make appropriate adjustments to this distance to accommodate growth in the child seated in the seat or to enable the stroller to be ridden by children of different heights.

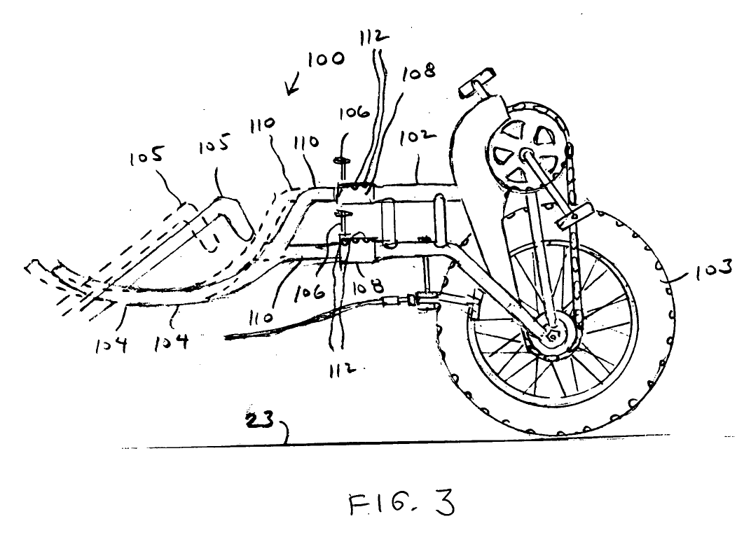

For example, there is illustrated in FIG. 3 a stroller embodiment, generally indicated 100, having a forward frame section 102 (to which is attached a rider-drivable front wheel 103) and a rearward frame section 104 (to which a seat 105 is attached) which are connectable to one another with a set of pins 106. The forward frame section 102 includes a pair of tubular sections 108 which are adapted to slidably accept a corresponding pair of tubular sections 110 of the rearward frame section 104, and each of the tubular sections 108 and 110 are provided with a set of pin-accepting apertures 112 which extend along the length thereof for selectively aligning with the apertures 112 of the other tubular sections 110 or 108. By removing the pins 106 from aligned apertures 112 of the tubular sections 108 and 110, shifting the tubular members 108 and 110 forwardly or rearwardly with respect to one another (by, for example, shifting the rearward frame section 104 relative to the forward frame section 102 between its solid and phantom-line positions illustrated in FIG. 3), and then re-inserting the pins 106 through an alternative set of aligned apertures 112, the distance between the seat 105 and the front wheel 103 (and thus the associated pedal assembly) can be altered.

Furthermore, although the depicted stroller 20 has been shown and described as utilizing a seat 38 capable of supporting only one child, an alternative embodiment of the stroller can include a seat whose width accommodates two or more children. It will be understood, however, that if in such an embodiment, only one child is to apply motive force to the stroller (by way of a pedal assembly), then that one child should be seated directly behind, or in front-to-back registry with, the pedal assembly for pedalling purposes.

Still further, although the aforedescribed stroller 20 has been shown and described herein as including few safety guards, other than the safety guard 99 (FIG. 2) disposed between the seat 38 and the rearwardmost run of the drive chain 84, an alternative stroller embodiment can employ other safety guards, such as one which can be removably connected to the frame 30 and positioned forwardly of the seat 38 so as to be disposed between the feet of a rider situated within the seat 38 and the pedal assembly 70. Such a removable safety guard provides a rider with a foot rest in the event that he becomes tired or simply doesn't wish to pedal the stroller anymore.

Moreover, although the aforedescribed embodiment 20 has been shown and described as including enabling means 70 by which a rider can apply rotary power to the front wheel 36, an alternative embodiment of the present invention can include means by which the rider can apply rotary power to the rear wheels 34.

Accordingly, the aforedescribed embodiment 20 is intended for the purpose of illustration and not as limitation.

1. A jogging stroller for carrying a rider as an individual jogs behind and pushes the stroller, the jogging stroller comprising:
a frame;
a plurality of wheels which are rotatably attached to the frame;
a seat supported by the frame within which a rider sits during use of the stroller;
a handle assembly associated with the frame enabling an individual who jogs behind the stroller to push the stroller as the handle assembly is grasped by the individual; and
means associated with the frame and connected in driving relationship with at least one of the wheels for enabling the rider to pedal the stroller along a road surface as the stroller is pushed along the road surface by the individual.

2. The stroller as defined in claim 1 wherein the frame has a front and a back, two wheels are disposed adjacent the back of the frame, one wheel is disposed adjacent the front of the frame, and the enabling means includes a set of foot pedals to which the rider is permitted to act upon with his feet.

3. The stroller as defined in claim 2 wherein the foot pedals are attached to the frame for rotation with respect thereto about an axis of rotation, and the stroller further includes a sprocket and drive chain arrangement connected between the foot pedals and the at least one wheel so that as the foot pedals are rotated relative to the frame about it rotation axis, the at least one wheel is rotated by way of the sprocket and drive chain arrangement by a corresponding amount.

4. The stroller as defined in claim 2 wherein the set of foot pedals are connected in driving relationship with the one wheel disposed adjacent the front of the frame.

5. The stroller as defined in claim 1 further comprising a braking assembly for braking a wheel of the stroller and being controllable by the individual who jogs behind and pushes the stroller.

6. The stroller as defined in claim 5 wherein the braking assembly includes a pair of brake pads supported on opposite sides of a wheel for movement into and out of engagement with the wheel and a cable which is connected at one end between the brake pads and being connected at the other end to the handle assembly of the frame so that as the cable is manipulated by the individual by way of the other end of the cable, the pads move into and out of engagement with the sides of the wheel.

7. The stroller as defined in claim 2 including means for altering the distance between the seat of the stroller and the set of foot pedals to permit the stroller to be pedaled from the seat by riders of different heights.

8. A jogging stroller for carrying a rider as an individual jogs behind and pushes the stroller along a road surface, the jogging stroller comprising:
a frame having a front and a back;
two back wheels which are rotatably attached to the frame adjacent the back of the frame;
a front wheel which is rotatably attached to the frame adjacent the front of the frame;
a seat supported by the frame within which a rider sits during use of the stroller;
a handle assembly associated with the frame enabling an individual who jogs behind the stroller to push the stroller along a road surface as the handle assembly is grasped by the individual; and
means associated with the frame and connected in driving relationship with at least one of the wheels for enabling the rider to pedal the stroller along a road surface as the stroller is pushed along the road surface by the individual, the enabling means including a set of foot pedals which are capable of being acted upon by the feet of the rider.

9. The stroller as defined in claim 8 wherein the foot pedals are attached to the frame for rotation with respect thereto about an axis of rotation, and the stroller further includes a sprocket and drive chain arrangement connected between the foot pedals and the at least one wheel so that as the foot pedals are rotated relative to the frame about it rotation axis, the at least one wheel is rotated by way of the sprocket and drive chain arrangement by a corresponding amount.

10. The stroller as defined in claim 8 wherein the set of foot pedals are connected in driving relationship with the front wheel disposed adjacent the front of the frame.

11. The stroller as defined in claim 8 further comprising a braking assembly for braking a wheel of the stroller and being controllable by the individual who jogs behind and pushes the stroller.

12. The stroller as defined in claim 11 wherein the braking assembly includes a pair of brake pads supported on opposite sides of a wheel for movement into and out of engagement with the wheel and a cable which is connected at one end between the brake pads and being connected at the other end to the handle assembly of the frame so that as the cable is manipulated by the individual by way of the other end of the cable, the pads move into and out of engagement with the sides of the wheel.

13. The stroller as defined in claim 8 including means for altering the distance between the seat of the stroller and the set of foot pedals to permit the stroller to be pedaled from the seat by riders of different heights.

14. A rider-assisted jogging stroller for carrying a rider as an individual jogs behind and pushes the stroller along a road surface, the jogging stroller comprising:
a frame having a front and a back;
two back wheels which are rotatably attached to the frame adjacent the back of the frame;
a front wheel which is rotatably attached to the frame adjacent the front of the frame;
a seat supported by the frame within which a rider sits during use of the stroller;
a frame including a handle assembly which enables an individual who jogs behind the stroller to push the stroller along a road surface as the handle assembly is grasped by the individual; and
a set of foot pedals which are rotatably supported by the frame for rotation which respect thereto about a rotation axis and which are accessible by the feet of a rider who sits within the seat, and the set of foot pedals are connected in driving relationship with the front wheel of the stroller so that as the set of pedals are rotated about the rotation axis, the front wheel of the stroller is rotated by a corresponding amount and aids the movement of the stroller along a road surface as the stroller is pushed therealong by the individual.

15. The stroller as defined in claim 14 further comprising a braking assembly for braking a wheel of the stroller and being controllable by the individual who jogs behind and pushes the stroller.

16. The stroller as defined in claim 15 wherein the braking assembly includes a pair of brake pads supported on opposite sides of a wheel for movement into and out of engagement with the wheel and a cable which is connected at one end between the brake pads and being connected at the other end to the handle assembly of the frame so that as the cable is manipulated by the individual by way of the other end of the cable, the pads move into and out of engagement with the sides of the wheel.

17. The stroller as defined in claim 14 including means for altering the distance between the seat of the stroller and the set of foot pedals to permit the stroller to be pedaled from the seat by riders of different heights.
